(19) United States
(12) Patent Application Publication
(10) Pub. No.: US 2024/0422455 A1
(43) Pub. Date: Dec. 19, 2024

(54) HYBRID ANALOG-TO-DIGITAL CONVERTER

(71) Applicant: SEMICONDUCTOR COMPONENTS INDUSTRIES, LLC, Scottsdale, AZ (US)

(72) Inventors: Ananthesh VENKATESH, Bangalore (IN); Mukul SARKAR, Scottsdale, AZ (US)

(73) Assignee: SEMICONDUCTOR COMPONENTS INDUSTRIES, LLC, Scottsdale, AZ (US)

(21) Appl. No.: 18/336,472

(22) Filed: Jun. 16, 2023

(51) Int. Cl. H04N 25/78; H04N 25/772

(52) U.S. Cl. CPC H04N 25/78; H04N 25/772

(57) ABSTRACT

A system may include a hybrid analog-to-digital converter (ADC) that forms a flash ADC in a first mode and a delta-sigma ADC is a second mode. The flash ADC may provide output resulting from a coarse analog-to-digital conversion. The output from the coarse analog-to-digital conversion may be used to configure the delta-sigma ADC to perform a fine analog-to-digital conversion.

### BACKGROUND

This relates generally to systems with analog-to-digital converters (ADCs), and more specifically, to ADCs in image sensors or imaging systems.

Image sensors are commonly used in electronic systems or devices to generate image data. In a typical arrangement, an image sensor includes an image sensor array having active image sensor pixels. Based on control signals received along control paths, the active image sensor pixels generate image signals in response to incident light. The generated image signals are read out along readout paths and are used to generate one or more image frames usable in the electronic system.

The pixel-generated image signals are analog signals that are converted to digital data by ADCs during readout operations. It may be desirable to provide an ADC with high conversion speeds and reduced power consumption while providing high bit resolution output.

### BRIEF DESCRIPTION OF THE DRAWINGS

FIG. 1 is a diagram of an illustrative system having one or more image sensors in accordance with some embodiments.

FIG. 2 is a diagram of illustrative image sensor circuitry having an image sensor pixel array and control and readout circuitry for the pixel array in accordance with some embodiments.

FIG. 3 is a diagram of illustrative hybrid analog-to-digital converter circuitry in accordance with some embodiments.

FIG. 4 is a graph showing illustrative signal level bins based on the light intensity of the corresponding pixel signal in accordance with some embodiments.

FIG. 5 is a diagram of an illustrative calibration circuit configured to store bin information in accordance with some embodiments.

FIG. 6 is a circuit diagram of an illustrative delta-sigma analog-to-digital converter configurable to operate in a flash mode of operation in accordance with some embodiments.

FIG. 7 is a circuit diagram of the delta-sigma analog-to-digital converter of FIG. 6 being configured to operate in a flash mode of operation in accordance with some embodiments.

### DETAILED DESCRIPTION

Electronic systems and/or devices may include one or more image sensors that gather incoming light to capture images. The image sensor may include one or more arrays of image sensor pixels. The pixels in the image sensor may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

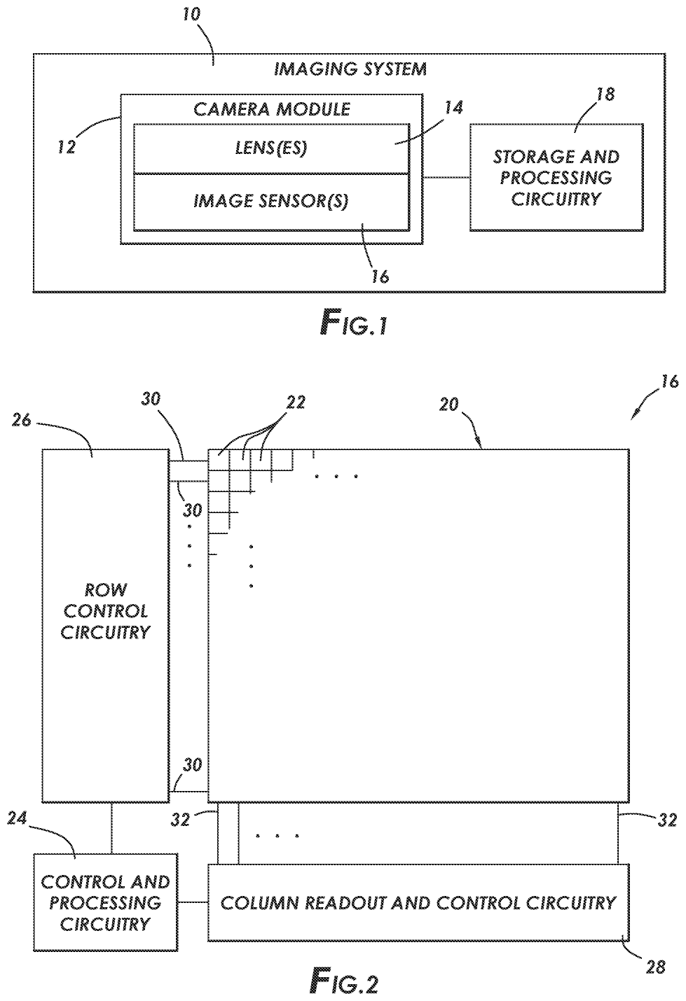

FIG. 1 is a functional block diagram of an illustrative imaging system such as an electronic device that uses an image sensor to capture images. Imaging system 10 of FIG. 1 may be a portable electronic device such as a camera, a cellular telephone, a tablet computer, a webcam, a video camera, a video surveillance system, an automotive imaging system, a video gaming system with imaging capabilities, an augmented reality and/or virtual reality system, an unmanned aerial vehicle system such as a drone, an industrial system, or any other desired imaging system or device that captures image data.

Camera module 12, sometimes referred to as an imaging module, may be used to convert incoming light into digital image data. Camera module 12 may include one or more lenses 14 and one or more image sensors 16. When capturing images, light from a scene may be focused onto each image sensor 16 by one or more lenses 14. Image sensor 16 may include circuitry for converting analog pixel image signals into corresponding digital image data that is provided to storage and processing circuitry 18.

Storage and processing circuitry 18 may include one or more integrated circuits, each serving data storage functions and/or data computation or processing functions. As examples, the one or more integrated circuits may include image processing circuits such as digital signal processors, application-specific integrated circuits, general-purpose processors, microprocessors, microcontrollers, storage devices such as random-access memory and non-volatile memory, and/or other types of integrated circuits having processors and/or memories.

Storage and processing circuitry 18 may be implemented using components that are separate from the camera module and/or components that form part of the camera module. As one example, storage and processing circuitry 18 may be implemented using circuits that form part of an integrated circuit that includes an image sensor 16 or an integrated circuit within camera module 12. When storage and processing circuitry 18 is included on different integrated circuits than those of image sensors 16, the integrated circuits with storage and processing circuitry 18 may be vertically stacked or packaged with respect to the integrated circuits with image sensors 16.

Image data that has been captured by camera module 12 may be processed and stored using processing circuitry 18. As examples, an image processing engine on processing circuitry 18, an imaging mode selection engine on processing circuitry 18, and/or other types of processing engines on processing circuitry 18 may process the image data captured by camera module 12. Processing circuitry 18 may, if desired, provide processed image data to external equipment such as a computer, an external display, or other devices using wired and/or wireless communication paths.

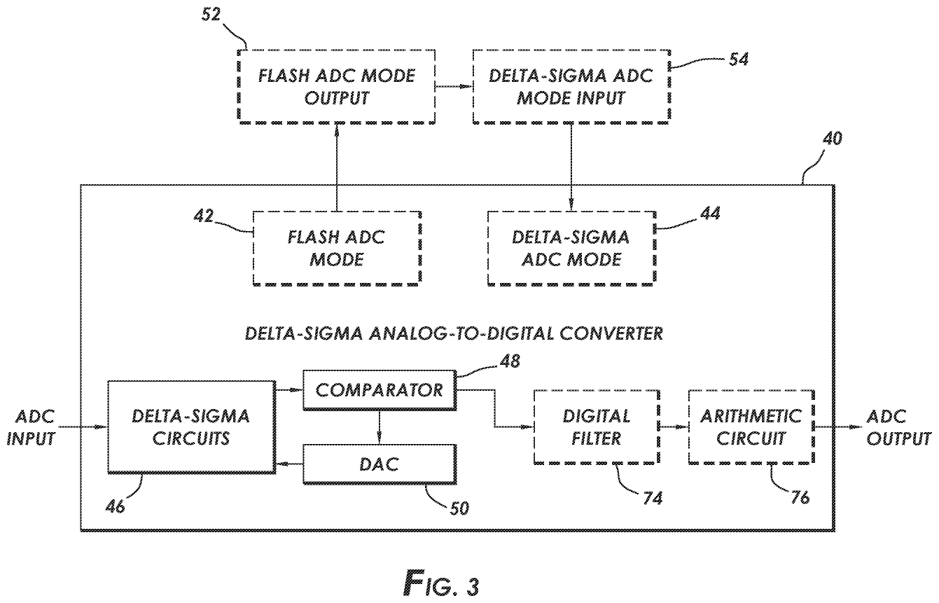

As shown in FIG. 2, image sensor 16 may include a pixel array such as pixel array 20 containing image sensor pixels 22, which are sometimes referred to herein as image pixels or pixels, arranged in rows and columns. A row of pixels or a column of pixels may sometimes be referred to herein generally as a line of pixels. Image sensor 16 may include control and processing circuitry 24, sometimes referred to herein as control circuitry 24, that controls the operation of pixel array 20. Pixel array 20 may contain, for example, hundreds or thousands of rows and columns of image sensor pixels 22. If desired, pixel array 20 may be provided with a filter array having multiple visible color or non-visible filter elements each corresponding to a respective pixel, thereby allowing a single image sensor to sample light of different colors or sets of wavelengths.

Image sensor pixels 22 may be formed in a semiconductor substrate using complementary metal-oxide-semiconductor (CMOS) technology or charge-coupled device (CCD) technology or any other suitable photosensitive device technology. Image sensor pixels 22 may be frontside illumination (FSI) image sensor pixels or backside illumination (BSI) image sensor pixels.

Control circuitry 24 may be coupled to pixel control circuitry such as row control circuitry 26 which includes row drivers that provide control signals to pixel array 20 and may be coupled to pixel readout circuitry such as column readout and control circuitry 28 that read out signals from pixel array 20.

Row control circuitry 26 may receive row addresses and/or signals indicative of row addresses from control circuitry 24 and supply corresponding row control signals such as reset, anti-blooming, row-select, charge transfer, dual conversion gain, and readout control signals to pixels 22 over conductive lines or paths 30 such as pixel row control paths. In particular, each pixel row may receive different control signals over a corresponding number of control paths such that each pixel row is coupled to multiple conductive paths 30. One or more conductive lines or paths 32 such as pixel column readout paths may be coupled to each column of pixels 22. Conductive paths 32 may be used for reading out image signals from pixels 22 and for supplying bias signals such as bias currents or bias voltages to pixels 22. As an example, when performing a pixel readout operation, a pixel row in pixel array 20 may be selected using row control circuitry 26 and image signals generated by the selected image pixels 22 in that pixel row can be read out along conductive paths 32.

Column readout circuitry 28 may receive image signals such as analog pixel values generated by pixels 22 over conductive paths 32. Column readout circuitry 28 may include memory or buffer circuitry for temporarily storing calibration signals such as reset level signals, reference level signals, and/or other non-image signals read out from array 20 and for temporarily storing image level signals read out from array 20, amplifier circuitry or a multiplier circuit, analog to digital converter (ADC) circuitry, bias circuitry, latch circuitry for selectively enabling or disabling portions of column readout circuitry 28, or other circuitry that is coupled to one or more columns of pixels in array 20 for operating pixels 22 and/or for reading out image signals from pixels 22. ADC circuitry in readout circuitry 28 may convert analog pixel values received from array 20 into corresponding digital pixel values, sometimes referred to as digital image data or digital pixel data. Column readout circuitry 28 may supply digital pixel data from pixels 22 in one or more pixel columns to control and processing circuitry 24 and/or processor 18 (FIG. 1) for further processing and/or storage.

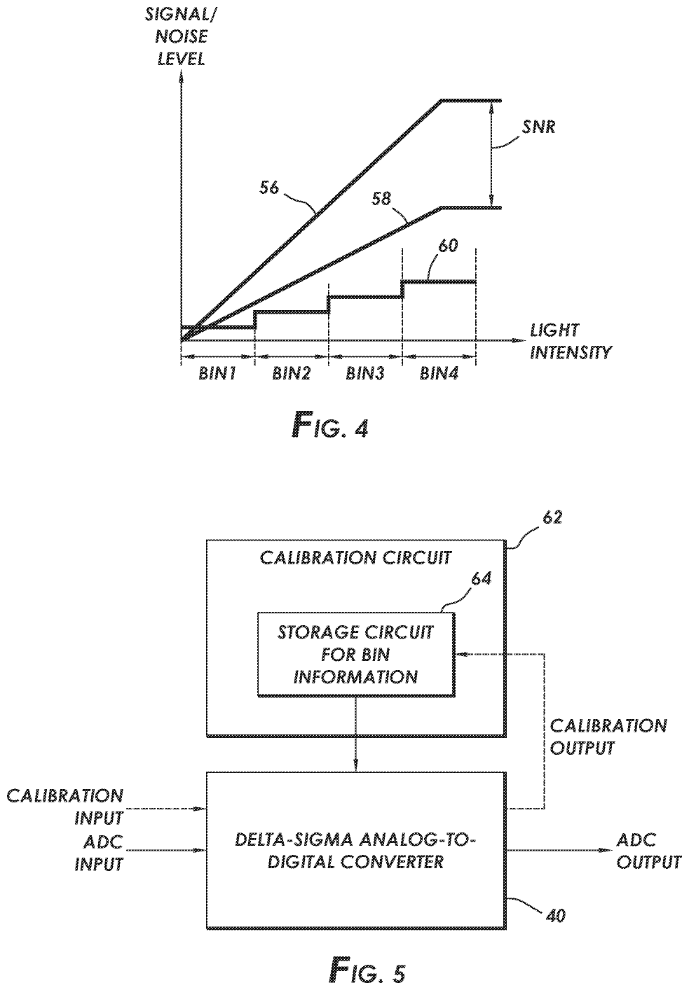

FIG. 3 shows illustrative analog-to-digital converter circuitry such as analog-to-digital converter 40 operable in both a flash ADC mode 42 and a delta-sigma ADC mode 44. ADC 40 may be coupled to one or more conductive paths 32 for one or more corresponding columns of pixels 22. ADC 40 may receive pixel-generated analog signals such as reset level signals and image level signals as ADC input and may convert these analog signals into corresponding digital data as ADC output. Pixel readout circuitry such as column readout circuitry 28 in FIG. 2 may include any suitable number of ADCs 40 that process the read out analog signals for different pixel columns in parallel.

ADC 40 may include a delta-sigma modulator having delta-sigma circuits 46, comparator 48 (sometimes referred to as a 1-bit ADC), and digital-to-analog converter (DAC) 50. ADC 40 may also include digital filter 74 and arithmetic circuit 76. Delta-sigma circuits 46 may include any suitable combination of delta circuits such as difference amplifiers and/or sigma circuits such as integrators or integrator amplifiers. For example, the delta-sigma circuits 46 may form a first-order delta-sigma modulator, a second-order delta-sigma modulator, or another higher-order delta sigma modulator. The downstream output of delta-sigma circuits 46 such as the most downstream integrator may be coupled to an input of comparator 48. DAC 50 may be coupled to a feedback path between an output of comparator 48 and delta-sigma circuits 46. DAC 50 may provide high and low reference voltages to delta-sigma circuits 46 based on the output of comparator 48. Digital filter 74 may include a decimation filter that receives the output of the comparator. Arithmetic circuit 76 such as adder and/or multiplier may provide selective scaling for the output of the digital filter 74 to generate the ADC output for ADC 40.

These components of ADC 40 are merely illustrative. If desired, ADC 40 may include any suitable additional components. Because the actual fine (high-resolution) analog-to-digital conversion is performed in delta-sigma ADC mode 44, ADC 40 is sometimes referred to herein as delta-sigma ADC 40.

Some of the components of ADC 40 such as comparator 48 and difference amplifier(s) and/or integrating amplifier(s) in delta-sigma circuits 46 may be shared in use between flash ADC mode 42 and delta-sigma ADC mode 44. In other words, when ADC 40 is configured to form a flash ADC in mode 42, one or more of comparator 48 and amplifiers in delta-sigma circuits 46 may form the flash ADC. When ADC 40 is configured to form a delta-sigma ADC in mode 44, the same components (e.g., the one or more of comparator 48 and amplifiers in delta-sigma circuits 46) may form the delta-sigma ADC. In such a manner, the additional functionalities imparted by delta-sigma ADC 40 serving as a flash ADC may be provided without the need to include at least some portions of a dedicated flash ADC, thereby desirably reducing the implementation area of ADC 40.

By operating ADC 40 first as a flash ADC in mode 42, ADC 40 may perform a coarse analog-to-digital conversion operation for an input analog signal. The results of the coarse conversion operation may be flash ADC mode output 52. Output 52 may include one, two, three, four, five, or any other suitable number of bits resulting from the coarse analog-to-digital conversion of the input analog signal. These one or more bits may help identify the light-intensity region or bin in which the input analog signal lies to help more efficiently perform the fine or actual analog-to-digital conversion of the input analog signal.

Subsequent to operation as a flash ADC, ADC 40 may operate as a delta-sigma ADC in mode 44. As a delta-sigma ADC, ADC 40 may perform a fine analog-to-digital conversion operation for the same input analog signal. The results of the fine conversion may be the ADC output corresponding the input analog signal. The ADC output may include any desired number of bits such as 8-bits, 10 bits, 12 bits, or any other bit resolution. The bit resolution (number of bits) of the digital data output by the fine conversion operation for the input analog signal is greater than the bit resolution (number of bits) of the digital data output by the coarse conversion operation for the input analog signal.

As shown in FIG. 3, operation of ADC 40 as a delta-sigma ADC in mode 44 may be based on output 52 of the coarse conversion operation. In particular, ADC 40 operating as a delta-sigma ADC in mode 44 may receive input 54 based on flash mode output 52. Input 54 may include one or more control signals, one or more control bits, and/or one or more control data received at one or more components of ADC 40. In such as a manner, input 54 may set the parameters of ADC 40 when operating in delta-sigma ADC mode 44 to optimize for conversion speed, power consumption, high bit resolution, and other operational characteristics dependent upon the characteristics of the analog input signal obtained upon the fast initial coarse conversion.

In arrangements described herein as an illustrative example, when operating in flash ADC mode 42, ADC 40 may generate bit information indicative of the light intensity of the input analog signal or generally the region on the photon transfer curve as output 52. The bit information may be indicative of different bins for different regions of light intensity and the corresponding dominance of the shot noise in these bins or regions.

FIG. 4 is a graph illustrating how these bins or regions may be defined based on the signal level of pixel-generated signals. In the example of FIG. 4, line 56 shows how the signal level of pixel-generated signals increases as image light intensity increases until the pixel-generated signal saturates. Line 58 shows the noise level of photon shot noise that increases as the square root of the pixel-generated signal level. The photon shot noise level also increases with the signal level of the pixel-generated signal until saturation. The ratio between the signal level and the total noise level defines the signal-to-noise ratio (SNR). In regions of the graph where shot noise is the dominant noise, SNR may be appropriately approximated as the ratio between the signal level and the noise level of the shot noise.

It may be desirable to classify any particular pixel-generated signal into different regions corresponding to different ranges of light intensities and associated with varying degrees of shot noise. These regions are sometimes referred to herein as bins and are shown as bins BIN1, BIN2, BIN3, and BIN4 in the example of FIG. 4.

In one illustrative configuration sometimes described herein as an example, ADC 40 (FIG. 3) operating in flash ADC mode 42 may generate a set of bits indicative of the corresponding bin to which the ADC input signal belongs as flash mode output 52. For example, the result of coarse conversions with pixel-generated signals associated with light intensities in bin BIN1 may be the binary (bit) value of “000”, the result of coarse conversions with pixel-generated signals associated with light intensities in bin BIN2 may be the binary (bit) value of “001”, the result of coarse conversions with pixel-generated signals associated with light intensities in bin BIN3 may be the binary (bit) value of “011”, and the result of coarse conversions with pixel-generated signals associated with light intensities in bin BIN4 may be the binary (bit) value of “111”.

Because ADC 40 operating in flash ADC mode 42 helps identify the region or bin to which the ADC input signal belongs (rather than the specific digital ADC output with the desired ADC output bit resolution), this initial classification operation, which is a flash ADC conversion operation, may sometimes be referred to as a coarse analog-to-digital conversion operation. Based on the coarse conversion output, ADC 40 may set its operating parameters for operating in delta-sigma ADC mode 44 and perform the fine conversion operation in mode 44.

Because ADC 40 sets the operating parameters for delta-sigma ADC mode 44 based on the bin to which the ADC input signal belongs, the operating parameters may help achieve high (fine) conversion speed, reduced power consumption, high ADC output bit resolution, and/or other properties as desired.

As an illustrative example, when ADC 40 is operating on an input signal in a region or a bin that is shot-noise-dominated such as in bins BIN2, BIN3, and BIN4, ADC 40 may change the DAC high and low reference voltages (e.g., the reference voltages supplied by DAC 50 to delta-sigma circuits 46 in FIG. 3), change the delta-sigma modulator clock frequency, and/or change the integrator amplifier bias current, relative to operating on an input signal in a region or a bin that is not shot-noise-dominated such as in bin BIN1. In fact, these parameters (e.g., DAC reference voltages, delta-sigma modulator clock frequency, and/or integrator amplifier bias current) may each be different or scaled across the shot-noise-dominated bins BIN2, BIN3, and BIN4, as desired.

By scaling the DAC reference voltages based on the bin to which the ADC input signal belongs, the quantization step of ADC 40 operating in delta-sigma ADC mode may be changed to reduce the number of conversion cycles to achieve the same bit output resolution across the different bins. This DAC reference voltage scaling for each bin is reflected in FIG. 4 by line 60 identifying the corresponding different quantization noise floor levels for the different bins exhibited by ADC 40. In some illustrative configurations described herein, the quantization noise floor levels may be adjustable by adjusting the oversampling rate (e.g., the clock frequency) of the delta-sigma modulator and/or the integrator amplifier bias current.

By scaling the delta-sigma modulator clock frequency and/or the integrator amplifier bias current (e.g., operating parameters of delta-sigma circuits 46), ADC 40 may operate with reduced power consumption.

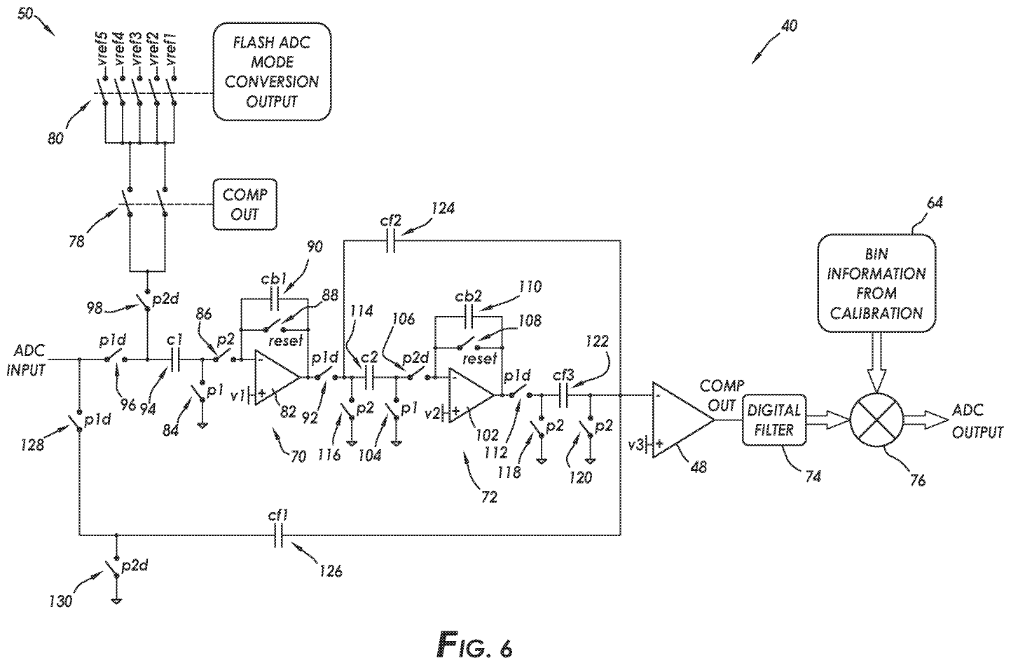

Because quantization steps differ across the bins, ADC 40 may compensate for the differing quantization steps by scaling the digital filter (e.g., decimator) output of delta-sigma ADC 40. In particular, to gather bin information that helps facilitate appropriate scaling for the digital filter output, ADC 40 may be calibrated prior to performing the coarse and fine conversion operations. As shown in FIG. 5, ADC 40 may be configured to receive calibration input and generate corresponding calibration output. The calibration output may be processed and/or stored in calibration circuit 62, or more specifically in storage circuit 64.

In particular, the calibration input can sweep or ramp through the ADC input voltage to identify the bin transitions such as transitions between bins BIN1 and BIN2, between bins BIN2 and BIN3, and between bins BIN3 and BIN4 (FIG. 4). In the example of FIG. 4, there may be three transitions to identify and a ramp signal may sweep from a voltage before the first transition to a voltage after the third transition.

In one illustrative arrangement, calibration circuit 62 may include a counter-based DAC that generates the ramp signal provided to delta-sigma analog-to-digital converter 40 as calibration input. As an example, each bin may span a voltage range of 250 millivolts (mV), the ramp signal may begin 100 mV before the first transition, and the ramp signal may end 100 mV after the last transition. Accordingly, the ramp signal may sweep 100 mV+250 mV+250 mV+100 mV=700 mV in total with a ramp resolution around 0.2 mV (e.g., around 1 least significant bit). ADC 40 may convert the swept voltages, every 0.2 mV between the 700 mV swept, in flash ADC mode to obtain the appropriate bin information in this example with 3500 ADC conversions. Storage circuit 64 may store the appropriate bin information corresponding to the transitions of the bins. Storage circuit 64 may be formed from line buffers.

As described in connection with FIG. 4, the result of coarse conversions associated with bin BIN1 may be the binary value of “000”, the result of coarse conversions associated with bin BIN2 may be the binary value of “001”, the result of coarse conversions associated with bin BIN3 may be the binary value of “011”, and the result of coarse conversions associated with bin BIN4 may be the binary value of “111”.

As the swept voltages of the calibration input ramp signal are converted, when the calibration output resulting from the conversion changes from the binary value of “000” to the binary value of “001”, the immediately prior ADC conversion calibration output may be stored as the end of bin BIN1 and the current ADC conversion calibration output may be stored as the offset or start of bin BIN2, thereby identifying the bin transition between bins BIN1 and BIN2. As the sweeping continues and additional voltages of the calibration input ramp signal are converted, when the calibration output resulting from the conversion changes from the binary value of “001” to the binary value of “011”, the immediately prior ADC conversion calibration output may be stored as the end of bin BIN2 and the current ADC conversion calibration output may be stored as the offset or start of bin BIN3, thereby identifying the bin transition between bins BIN2 and BIN3. As the sweeping continues and additional voltages of the calibration input ramp signal are converted, when the calibration output resulting from the conversion changes from the binary value of “011” to the binary value of “111”, the immediately prior ADC conversion calibration output may be stored as the end of bin BIN3 and the current ADC conversion calibration output may be stored as the offset or start of bin BIN4, thereby identifying the bin transition between bins BIN3 and BIN4.

In particular, from the calibration process above, ADC 40 may store (e.g., at storage circuit 64), the ADC conversion calibration output for the end of bin BIN1 (i.e., BIN1-end), the ADC conversion calibration output for the offset (or start) of bin BIN2 (i.e., BIN2-offset), the ADC conversion calibration output for the end of bin BIN2 (i.e., BIN2-end), the ADC conversion calibration output for the offset (or start) of bin BIN3 (i.e., BIN3-offset), the ADC conversion calibration output for the end of bin BIN3 (i.e., BIN3-end), and the ADC conversion calibration output for the offset (or start) of bin BIN4 (i.e., BIN4-offset).

By obtaining these bin transition values, ADC 40 may appropriately scale the output from the digital filter in ADC 40 to generate the appropriate ADC output while accounting for the quantization step.

As a first example, if the pixel-generated signal and the corresponding digital filter output (i.e., DOUT) are in bin BIN1, there is no scaling factor needed and the digital filter output may be passed through as the ADC output (i.e., ADCOUT). In other words, ADCOUT=DOUT.

As a second example, if the pixel-generated signal and the corresponding digital filter output (i.e., DOUT) are in bin BIN2, ADC 40 may calculate the ADC output (i.e., ADCOUT) based on the following equation: ADCOUT=BIN1-end+((DOUT−BIN2-offset)*2), where 2 is an illustrative scaling factor for bin BIN2.

As a third example, if the pixel-generated signal and the corresponding digital filter output (i.e., DOUT) are in bin BIN3, ADC 40 may calculate the ADC output (i.e., ADCOUT) based on the following equation: ADCOUT=BIN1-end+((BIN2-end−BIN2-offset)*2)+((DOUT−BIN3-offset)*4), where 2 is an illustrative scaling factor for bin BIN2 and 4 is an illustrative scaling factor for bin BIN3.

As a fourth example, if the pixel-generated signal and the corresponding digital filter output (i.e., DOUT) are in bin BIN4, ADC 40 may calculate the ADC output (i.e., ADCOUT) based on the following equation: ADCOUT=BIN1-end+_((BIN2-end−BIN2-offset)*2)+((BIN3-end−BIN3-offset)*4)+((DOUT−BIN4-offset)*8)), where 2 is an illustrative scaling factor for bin BIN2, 4 is an illustrative scaling factor for bin BIN3, and 8 is an illustrative scaling factor for bin BIN4.

ADC 40 can identify the portions of the digital filter output in each of the bins based on the calibration described in connection with FIG. 5. In other words, ADC 40 may obtain the bin information such as the corresponding digital output associated with the end of bin BIN1, the start of bin BIN2, the end of bin BIN2, the start of bin BIN3, the end of bin BIN3, and the start of bin BIN4 from storage circuit 64 to perform the above-mentioned scaling calculations.

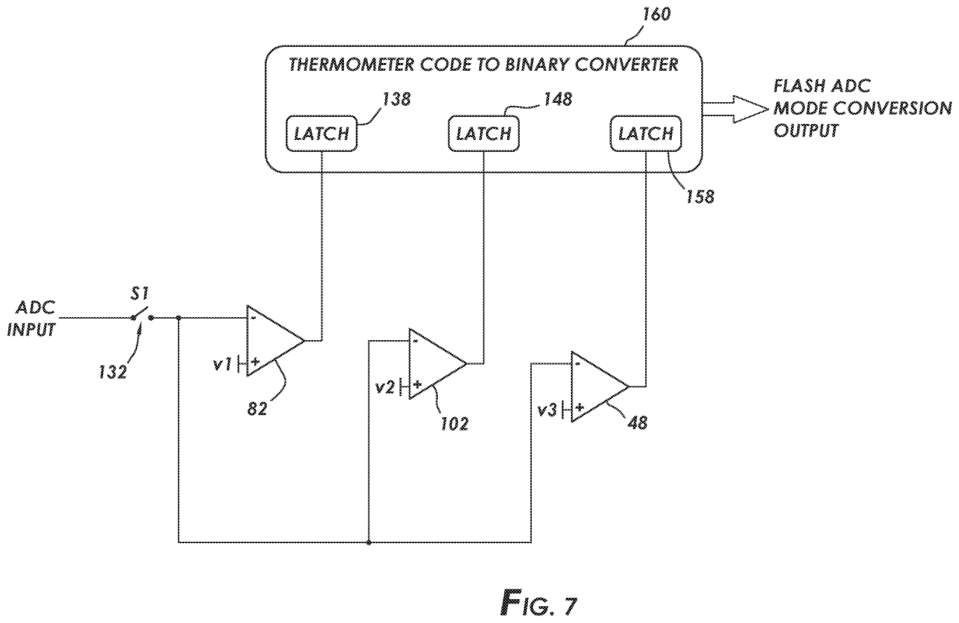

FIG. 6 is a circuit diagram of an illustrative configuration of ADC 40. In the example of FIG. 6, ADC 40 includes a first integrator 70 or sigma circuit 70, a second integrator 72 or sigma circuit 72, comparator 48, DAC 50, digital filter 74, and an arithmetic circuit 76. Integrators 70 and 72 and the switches coupled to integrators 70 and 72 and operable based on different phases may form delta-sigma circuit 46 (FIG. 3).

Integrator 70 may include operational amplifier 82 having a first (non-inverting) input terminal coupled to a reference voltage terminal and configured to receive reference voltage V1. Amplifier 82 has a second (inverting) input terminal coupled to the input terminal of ADC 40 and configured to receive the ADC input analog signal along an input path. Switch 86, capacitor 94, and switch 96 may be coupled between the second input terminal and the input terminal of ADC 40 along the input path. Switch 84, in combination with switch 86, may couple the second input terminal of amplifier 82 to a reference voltage terminal.

Amplifier 82 has an output terminal coupled to integrator 72. Reset switch 88 may be coupled between the second input terminal of amplifier 82 and the output terminal of amplifier 82 along a first path. Capacitor 90 may be coupled between the second input terminal of amplifier 82 and the output terminal of amplifier 82 along a second path parallel to the first path.

Integrator 72 may include operational amplifier 102 having a first (non-inverting) input terminal coupled to a reference voltage terminal and configured to receive reference voltage V2. Amplifier 102 has a second (inverting) input terminal coupled to the output terminal of amplifier 82 and configured to receive the output signal of amplifier 82 along an input path. Switch 106, capacitor 114, and switch 92 may be coupled between the second input terminal of amplifier 102 and the output terminal of amplifier 82 along the input path. Switch 104, in combination with switch 106, may couple the second input terminal of amplifier 102 (and a first terminal of capacitor 114) to a reference voltage terminal. Switch 116 may couple an opposing second terminal of capacitor 114 to a reference voltage terminal.

Amplifier 102 has an output terminal coupled to comparator 48. Reset switch 108 may be coupled between the second input terminal of amplifier 102 and the output terminal of amplifier 102 along a first path. Capacitor 110 may be coupled between the second input terminal of amplifier 102 and the output terminal of amplifier 102 along a second path parallel to the first path.

Comparator 48 may be formed from an operational amplifier having a first (non-inverting) input terminal coupled to a reference voltage terminal and configured to receive reference voltage V3. The amplifier forming comparator 48 may have a second (inverting) input terminal coupled to the output terminal of amplifier 102 and configured to receive the output signal of amplifier 102 along an input path. Switch 112 and capacitor 122 may be coupled between the second input terminal of the amplifier of comparator 48 and the output terminal of amplifier 102 along the input path. Switch 120 may couple the second input terminal of the amplifier of comparator 48 (and a first terminal of capacitor 122) to a reference voltage terminal. Switch 118 may couple an opposing second terminal of capacitor 122 to a reference voltage terminal.

Capacitor 124 may be coupled between the second input terminal of the amplifier of comparator 48 and the output terminal of amplifier 82 (between switch 92 and capacitor 114) along a first path. Capacitor 126 and switch 128 may be coupled between the second input terminal of the amplifier of comparator 48 and the input terminal of ADC 40 along a second path. Switch 130 may be couple the second path (between capacitor 126 and switch 128) to a reference voltage terminal.

The states of switches 84 and 104 may be controlled by control signal p1. The states of switches 92, 96, 112, and 128 may be controlled by control signal p1d (e.g., a delayed version of control signal p1). The states of switches 86, 116, 118, and 120 may be controlled by control signal p2 (e.g., an inverted version of control signal p1). The states of switches 98, 106, and 130 may be controlled by control signal p2d (e.g., a delayed version of control signal p2). Control signals p1 and p2 may be non-overlapping clocks (e.g., the assertion of the clock signals are non-overlapping). Control circuitry (e.g., a microcontroller, a processor, etc.) may supply these control signals to switches to operate ADC 40 in two phases: the p1/p1d phase and the p2/p2d phase.

Comparator 48, or more specifically the amplifier forming comparator 48, may have an output terminal coupled to digital filter 74. Digital filter 74 may include a decimation filter and/or other types of digital filters. Comparator output signal COMP OUT may be generated at the output terminal and provided to digital filter 74. Additionally, comparator output signal COMP OUT may be supplied to DAC 50 as a control signal.

As shown in FIG. 6, DAC 50 in ADC 40 may be coupled to the ADC input terminal and the second input terminal of amplifier 82. In particular, DAC 50 may be coupled, via switch 98, to the input path (between capacitor 94 and switch 96). DAC 50 may include two switches 78 configured to provide high and low reference voltages to the input path (e.g., to the second input terminal of amplifier 82). In other words, a first switch 78 may provide a high reference voltage while a second switch 78 may provide a low reference voltage. Comparator output signal COMP OUT may be supplied as control signals to switches 78. Signal COMP OUT may selectively provide one of the high reference voltage (via the first switch 78) or the low reference voltage (via the second switch 78) to the input path and the second input terminal of amplifier 82 via capacitor 94.

DAC 50 may include a plurality of reference voltage terminals respectively supplying different voltages and may include a corresponding number switches 80 that provide one of the reference voltages as the high reference voltage of DAC 50 and another one of the reference voltages as the low reference voltage of DAC 50. While in the example of FIG. 6, five illustrative reference voltage terminals and five corresponding switches 80 are shown, this is merely illustrative. In configurations in which four bins (e.g., bins BIN1, BIN2, BIN3, and BIN4) are provided, it may be desirable to provide eight reference voltage terminals respectively supplying eight different voltages vref1, verf2, vref3, vref4, and vref5 (as shown in FIG. 6), and vref6, vref7, and vref8 (not explicitly shown in FIG. 6) and eight corresponding switches 80. In particular, for each bin, a different pair of different voltages may be provided as the high and low reference voltages of DAC 50.

As an example, for bin 1, voltage vref1 (e.g., 2.0 volts (V)) may be used as the high reference voltage of DAC 50 and voltage vref2 (e.g., 1.8 V) may be used as the low reference voltage of DAC 50. As another example, for bin 2, voltage vref3 (e.g., 1.85 V) may be used as the high reference voltage of DAC 50 and voltage vref4 (e.g., 1.5 V) may be used as the low reference voltage of DAC 50.

The flash ADC mode coarse conversion may generate output (e.g., a set of bits such as “000”, “001”, “011”, and “111” in the example of FIG. 4 indicating bins). The coarse conversion output of the ADC input may be used as an input to configure the states of switches 80, thereby selecting the two appropriate reference voltages to be used as the high and low reference voltages of DAC 50.

As described in connection with FIG. 4, the voltage levels of the high and low reference voltages of DAC 50 may define a quantization step of the delta-sigma circuits. Accordingly, by adjusting the high and low reference voltages (e.g., selecting the desired high and low reference voltages) and therefore the quantization step, the number of cycles for converting the ADC input signal to a particular bit resolution output may be decreased.

In addition to selecting the appropriate pair of high and low reference voltages of DAC 50, ADC 40 may also be configured to adjust (e.g., scale) the delta-sigma modulator clock frequency (sometimes referred to as the oversampling rate) and/or adjust (e.g., scale) the integrator amplifier bias current. In some illustrative configurations described herein as an example (e.g., the configuration of ADC 40 in FIG. 6), the clock frequency of the signals p1. p1d, p2, and/or p2d (FIG. 6) may be or be indicative of the delta-sigma modulator clock frequency and may be scaled accordingly, and the internal bias current of integrators 70 and/or 72 may be scaled accordingly to adjust the integrator amplifier bias current. The scaling of one or more of these two parameters (e.g., the delta-sigma modulator clock frequency, and/or the integrator amplifier bias current) may also scale the quantization noise floor (e.g., create the steps of line 60 in FIG. 4), which reduces power consumption. As an example, for bin BIN1, the delta-sigma modulator clock frequency may be f Hertz (Hz) and the integrator comparator bias current may be I milliamperes (mA). As another example, for bin BIN2, the delta-sigma modulator clock frequency may be f/x Hz and the integrator comparator bias current may be I/x mA, where x is a scaling factor for bin BIN2 greater than 1. As yet another example, for bin BIN3, the delta-sigma modulator clock frequency may be f/y Hz and the integrator comparator bias current may be I/y mA, where y is a scaling factor for bin BIN3 greater than x.

Digital filter 74 may be coupled to arithmetic circuit 76, which receives and selectively scales the output of digital filter 74 based on the bin information obtained from the calibration operation described in connection with FIG. 5 and stored at storage circuit 64. Arithmetic circuit 76 may include multiplier circuits and/or adder circuits that selectively multiplies portions of the digital filter output with corresponding scaling factor(s) and adds the corresponding scaled portions of the digital filter output together in the same manner as described above in connection with FIG. 5. This scaling may help linearize the (output) response obtained by digital filter 74.

If desired, arithmetic circuit 76 may be omitted and the output response of digital filter 74 may not be linearized. Accordingly, by not applying the corresponding scaling factor, the dynamic range of the digital filter response may be extended and ADC 40 may operate with an extended dynamic range.

Whereas FIG. 6 shows some portions of ADC 40 forming a delta-sigma ADC in mode 44, FIG. 7 shows other portions of ADC 40 forming a flash ADC in mode 42. In the example of FIG. 7, amplifier 82 (e.g., for integrator 70 in FIG. 6), amplifier 102 (e.g., for integrator 72 in FIG. 6), and the amplifier for comparator 48 (also in FIG. 6), may be used for the flash ADC in addition to forming elements of the delta-sigma ADC in FIG. 6.

In particular, the first (non-inverting) input terminal of amplifier 82 may be configured to receive a reference voltage V1, which may be the same as or different than the reference voltage V1 in the delta-sigma mode configuration of FIG. 6. The second (inverting) input terminal may be coupled to the ADC input terminal of ADC 40 via switch 132. The output terminal of amplifier 82 may be coupled to latch 138.

The first (non-inverting) input terminal of amplifier 102 may be configured to receive a reference voltage V2, which may be the same as or different than the reference voltage V2 in the delta-sigma mode configuration of FIG. 6. The second (inverting) input terminal may be coupled to the ADC input terminal of ADC 40 via switch 132. The output terminal of amplifier 102 may be coupled to latch 148.

The first (non-inverting) input terminal of the amplifier for comparator 48 may be configured to receive a reference voltage V3, which may be the same as or different than the reference voltage V3 in the delta-sigma mode configuration of FIG. 6. The second (inverting) input terminal may be coupled to the ADC input terminal of ADC 40 via switch 132. The output terminal of the amplifier for comparator 48 may be coupled to latch 158.

Amplifiers 82, 102, and 48 may each be configured to provide a corresponding bit to latches 138, 148, and 158 (e.g., strong-arm latches), respectively, based on comparing the same analog input voltage to different reference voltages V1, V2, and V3. In other words, amplifiers 82, 102, and 48 may form three corresponding comparators or 1-bit ADCs for the flash ADC configuration of ADC 40. Binary converter 160 may convert the three stored bits in latches 138, 148, and 158 to a corresponding binary value as the flash ADC mode conversion output. The flash ADC mode conversion output may be used to control the state of switches 80 in DAC 50 (FIG. 6) in selecting the appropriate high and low reference voltages for DAC 50.

While various elements of ADC 40 are described separately in FIGS. 6 and 7, this is merely illustrative and is done in order to not unnecessarily obscure the various aspects of ADC 40. The elements of ADC 40 described in connection with FIGS. 6 and 7 may be implemented in a single ADC 40. For example, ADC 40 as shown in FIG. 6 may additionally include switch 132, latches 138, 148, and 158, converter 160, and the paths coupled to each of these elements as shown in FIG. 7.

Various embodiments have been described illustrating a hybrid ADC operable as a flash ADC and a delta-sigma ADC.

As a first example, an image sensor may include an array of image sensor pixels and pixel readout circuitry coupled to the array of image sensor pixels. The pixel readout circuitry may include an analog-to-digital converter configured to operate as a flash analog-to-digital converter in a first mode and a delta-sigma analog-to-digital converter in a second mode. In particular, the analog-to-digital converter may be configured to perform a coarse conversion operation on a pixel signal when operating as the flash analog-to-digital converter and may be configured to perform a fine conversion operation on the pixel signal when operating as the delta-sigma analog-to-digital converter. The coarse conversion operation produces first digital data having fewer bits than second digital data produced by the fine conversion operation. The analog-to-digital converter may be configured to perform the fine conversion operation on the pixel signal based on an output of the coarse conversion operation on the pixel signal.

If desired, the analog-to-digital converter may include an amplifier that forms part of the flash analog-to-digital converter in the first mode and forms part of the delta-sigma analog-to-digital converter in the second mode. The amplifier may be configured to form a comparator for the flash analog-to-digital converter in the first mode and may be configured to form an integrator or a comparator for the delta-sigma analog-to-digital converter in the second mode. If desired, the analog-to-digital converter may include first and second additional amplifiers that form part of the flash analog-to-digital converter in the first mode and form part of the delta-sigma analog-to-digital converter in the second mode. The analog-to-digital converter may include a digital-to-analog converter coupled to the amplifier, a digital filter coupled to the amplifier, and an arithmetic circuit coupled to the digital filter. The digital-to-analog converter may be coupled between an output terminal of the amplifier and an input terminal of the first additional amplifier. An output terminal of the first additional amplifier may be coupled to an input terminal of the second additional amplifier. An output terminal of the second additional amplifier may be coupled to an input terminal of the amplifier. The digital filter may be coupled to the output terminal of the amplifier. The arithmetic circuit may be coupled to the output terminal of the digital filter.

As a second example, an analog-to-digital converter may be configured to receive an input analog signal The analog-to-digital converter may include a delta-sigma circuit, a comparator coupled to the delta-sigma circuit and having an output terminal, a digital filter coupled to the output terminal of the comparator, and a digital-to-analog converter coupled between the output terminal of the comparator and the delta-sigma circuit and configured to supply the delta-sigma circuit with high and low reference voltages based on a signal on the output terminal of the comparator. The digital-to-analog converter may be configured to select the high reference voltage from multiple voltages and to select the low reference voltage from multiple voltages. If desired, the delta-sigma circuit and the comparator may be configured to perform at least part of a first analog-to-digital conversion for the input analog signal. The digital-to-analog converter may be configured to select the high reference voltage from multiple voltages based on the first analog-to-digital conversion and to select the low reference voltage from multiple voltages based on the first analog-to-digital conversion. The digital-to-analog converter may be configured to perform at least part of a second analog-to-digital conversion for the input analog signal using the selected high and low reference voltages. The analog-to-digital converter may include an arithmetic circuit coupled to an output terminal of the digital filter and configured to obtain calibration information from a storage circuit and to selectively scale an output on the output terminal of the digital filter based on the calibration information.

As a third example, a delta-sigma analog-to-digital converter may be configured to receive an input analog signal. The delta-sigma analog-to-digital converter may include a delta-sigma circuit, a digital-to-analog converter coupled to the delta-sigma circuit, a comparator coupled to the delta-sigma circuit, and a digital filter coupled to the comparator. The delta-sigma circuit may include an amplifier. The amplifier and the comparator may be configured to form a portion of a flash analog-to-digital converter.

The flash analog-to-digital converter may be configured to provide an indication of a bin to which the input analog signal belongs, the bin being associated with a range of image light intensities. The delta-sigma analog-to-digital converter may be configured to perform an analog-to-digital conversion of the input analog signals based on the indication of the bin. In particular, the digital-to-analog converter may be configured to select high and low reference voltages based on the indication of the bin. The delta-sigma circuit, the comparator, and the digital-to-analog converter may at least partly form a delta-sigma modulator. A clock frequency of the delta-sigma modulator may be adjusted based on the indication of the bin. A bias current of an amplifier of the delta-sigma modulator may be adjusted based on the indication of the bin.

It will be recognized by one skilled in the art that the present exemplary embodiments may be practiced without some or all of these specific details. In other instances, well-known operations have not been described in detail in order not to unnecessarily obscure the present embodiments.

The foregoing is merely illustrative and various modifications can be made to the described embodiments. The foregoing embodiments may be implemented individually or in any combination.

What is claimed is:

1. An image sensor comprising:
an array of image sensor pixels; and
pixel readout circuitry coupled to the array of image sensor pixels, wherein the pixel readout circuitry comprises an analog-to-digital converter configured to operate as a flash analog-to-digital converter in a first mode and a delta-sigma analog-to-digital converter in a second mode.

2. The image sensor defined in claim 1, wherein the analog-to-digital converter is configured to perform a coarse conversion operation on a pixel signal when operating as the flash analog-to-digital converter and wherein the analog-to-digital converter is configured to perform a fine conversion operation on the pixel signal when operating as the delta-sigma analog-to-digital converter.

3. The image sensor defined in claim 2, wherein the coarse conversion operation produces first digital data having fewer bits than second digital data produced by the fine conversion operation.

4. The image sensor defined in claim 2, wherein the analog-to-digital converter is configured to perform the fine conversion operation on the pixel signal based on an output of the coarse conversion operation on the pixel signal.

5. The image sensor defined in claim 1, wherein the analog-to-digital converter comprises an amplifier that is part of the flash analog-to-digital converter in the first mode and is part of the delta-sigma analog-to-digital converter in the second mode.

6. The image sensor defined in claim 5, wherein the amplifier is configured to operate as a comparator for the flash analog-to-digital converter in the first mode and is configured to form an integrator for the delta-sigma analog-to-digital converter in the second mode.

7. The image sensor defined in claim 5, wherein the amplifier is configured to operate as a comparator for the flash analog-to-digital converter in the first mode and is configured to operate as a comparator for the delta-sigma analog-to-digital converter in the second mode.

8. The image sensor defined in claim 7, wherein the analog-to-digital converter comprises first and second additional amplifiers that are part of the flash analog-to-digital converter in the first mode and are part of the delta-sigma analog-to-digital converter in the second mode.

9. The image sensor defined in claim 8, wherein the analog-to-digital converter comprises a digital-to-analog converter coupled to the amplifier, a digital filter coupled to the amplifier, and an arithmetic circuit coupled to the digital filter.

10. The image sensor defined in claim 9, wherein the digital-to-analog converter is coupled between an output terminal of the amplifier and an input terminal of the first additional amplifier, wherein an output terminal of the first additional amplifier is coupled to an input terminal of the second additional amplifier, wherein an output terminal of the second additional amplifier is coupled to an input terminal of the amplifier, wherein the digital filter is coupled to the output terminal of the amplifier, and wherein the arithmetic circuit is coupled to an output terminal of the digital filter.

11. An analog-to-digital converter configured to receive an input analog signal, the analog-to-digital converter comprising:
a delta-sigma circuit;
a comparator coupled to the delta-sigma circuit and having an output terminal;
a digital filter coupled to the output terminal of the comparator; and
a digital-to-analog converter coupled between the output terminal of the comparator and the delta-sigma circuit and configured to supply the delta-sigma circuit with high and low reference voltages based on a signal on the output terminal of the comparator, wherein the digital-to-analog converter is configured to select the high reference voltage from multiple voltages and to select the low reference voltage from multiple voltages.

12. The analog-to-digital converter defined in claim 11, wherein the delta-sigma circuit and the comparator are configured to perform at least part of a first analog-to-digital conversion for the input analog signal and wherein the digital-to-analog converter is configured to select the high reference voltage from multiple voltages based on the first analog-to-digital conversion and to select the low reference voltage from multiple voltages based on the first analog-to-digital conversion.

13. The analog-to-digital converter defined in claim 12, wherein the digital-to-analog converter is configured to perform at least part of a second analog-to-digital conversion for the input analog signal using the selected high and low reference voltages.

14. The analog-to-digital converter defined in claim 11 further comprising:
an arithmetic circuit coupled to an output terminal of the digital filter and configured to selectively scale an output on the output terminal of the digital filter.

15. The analog-to-digital converter defined in claim 14, wherein the arithmetic circuit is configured to obtain calibration information from a storage circuit and to selectively scale the output on the output terminal of the digital filter based on the calibration information.

16. A delta-sigma analog-to-digital converter configured to receive an input analog signal, the delta-sigma analog-to-digital converter comprising:
a delta-sigma circuit;
a digital-to-analog converter coupled to the delta-sigma circuit;
a comparator coupled to the delta-sigma circuit; and
a digital filter coupled to the comparator, wherein the delta-sigma circuit comprises an amplifier and wherein the amplifier and the comparator are configured to operate as a portion of a flash analog-to-digital converter.

17. The delta-sigma analog-to-digital converter defined in claim 16, wherein the flash analog-to-digital converter is configured to provide an indication of a bin to which the input analog signal belongs, the bin being associated with a range of image light intensities.

18. The delta-sigma analog-to-digital converter defined in claim 17, wherein the delta-sigma analog-to-digital converter is configured to perform an analog-to-digital conversion of the input analog signal based on the indication of the bin.

19. The delta-sigma analog-to-digital converter defined in claim 17, wherein the digital-to-analog converter is configured to select high and low reference voltages based on the indication of the bin.

20. The delta-sigma analog-to-digital converter defined in claim 17, wherein the delta-sigma circuit, the comparator, and the digital-to-analog converter are configured to operate as at least a portion of a delta-sigma modulator, wherein a clock frequency of the delta-sigma modulator is adjusted based on the indication of the bin, and wherein a bias current of an amplifier of the delta-sigma modulator is adjusted based on the indication of the bin.
